(19) United States
(12) Patent Application Publication
(10) Pub. No.: US 2024/0211007 A1
(43) Pub. Date: Jun. 27, 2024

(54) INFORMATION PROCESSING DEVICE

(71) Applicant: TOSHIBA TEC KABUSHIKI KAISHA, Tokyo (JP)

(72) Inventor: Naoya Misawa, Numazu Shizuoka (JP)

(21) Appl. No.: 18/359,919

(22) Filed: Jul. 27, 2023

(30) Foreign Application Priority Data
Dec. 22, 2022 (JP) 2022-205804

(51) Int. Cl. G06F 1/18

(52) U.S. Cl. CPC G06F 1/186

(57) ABSTRACT

In general, according to one embodiment, an information processing device that can be miniaturized by sharing maintenance hardware between control boards is provided. An information processing device according to an embodiment provided in a housing with a plurality of control boards on which processors and memories are mounted, and functioning by processes of the processors mounted on the plurality of control boards, the information processing device includes: maintenance hardware configured to be used when maintenance is performed on the information processing device; and a switching unit configured to selectively connect an input and output port of any one of the plurality of control boards to the maintenance hardware.

### CROSS-REFERENCE TO RELATED APPLICATION

This application is based upon and claims the benefit of priority from Japanese Patent Application No. 2022-205804, filed on Dec. 22, 2022, the entire contents of which are incorporated herein by reference.

### FIELD

Embodiments described herein relate generally to an information processing device.

### BACKGROUND

In the related art, there is known an information processing device such as a personal computer in which two motherboards are accommodated in one housing and the motherboards can be switched for use. Further, there is also known one information processing device including a plurality of motherboards in order to distribute processes for implementing functions of the information processing device.

Here, in the information processing device such as a server device, maintenance is performed periodically or irregularly by a service person or the like. In the maintenance, maintenance hardware of the information processing device is used. Examples of the maintenance hardware include a universal serial bus (USB) connector to which an external device is connected, a reset switch that resets a processor, and a status light emitting diode (LED) that indicates an abnormal state of the hardware.

In the above-described information processing device including the plurality of motherboards in the related art, the maintenance hardware is mounted on each motherboard. Therefore, there is a problem that a size of the device becomes large.

### DESCRIPTION OF THE DRAWINGS

FIG. 1 is a diagram showing a configuration of a POS system including a server device according to an embodiment;

FIG. 2 is a block diagram showing a main electrical configuration;

FIG. 3 is a diagram showing an outer surface of a housing;

FIG. 4 is a diagram illustrating switching between an input and output port of a control board and maintenance hardware; and

FIG. 5 is a flowchart showing a flow of a switching process.

### DETAILED DESCRIPTION

In general, according to one embodiment, an information processing device that can be miniaturized by sharing maintenance hardware between control boards is provided.

An information processing device according to an embodiment provided in a housing with a plurality of control boards on which processors and memories are mounted, and functioning by processes of the processors mounted on the plurality of control boards, the information processing device includes: maintenance hardware configured to be used when maintenance is performed on the information processing device; and a switching unit configured to selectively connect an input and output port of any one of the plurality of control boards to the maintenance hardware.

Hereinafter, an information processing device according to an embodiment will be described in detail with reference to the drawings. Exemplary embodiments described herein are not limited to those to be described later. For example, in the embodiment described below, an example in which an information processing device is applied to a server device used in a point of sales (POS) system of a store will be described, but the exemplary embodiment is not limited thereto. The information processing device is widely applicable to devices that include a processor and process data, such as a POS terminal, a personal computer, and various server devices.

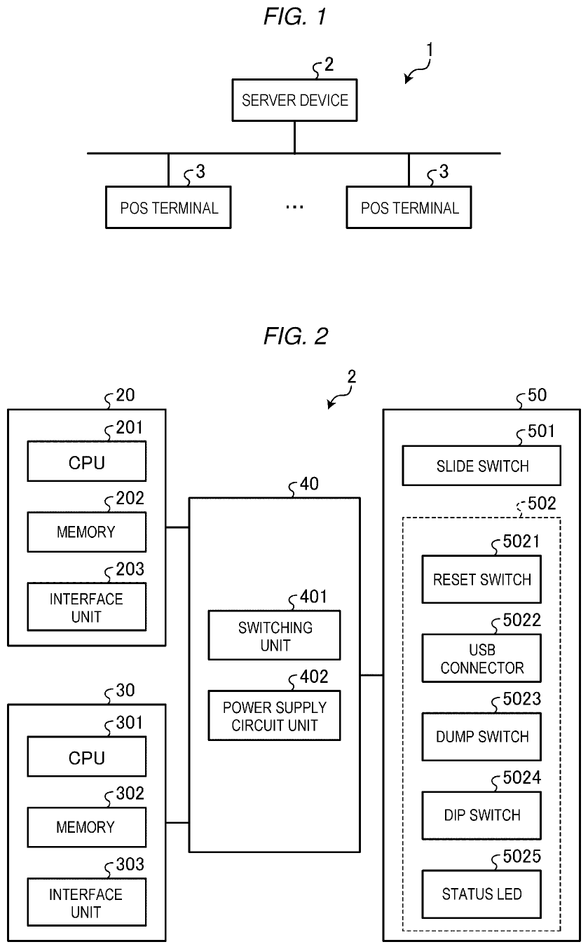

FIG. 1 is a diagram showing a configuration of a POS system 1. The POS system 1 is applied to a store that sells commodities or services (hereinafter, collectively referred to as “commodities”). The POS system 1 includes a server device 2 and a plurality of POS terminals 3. The server device 2 and the POS terminals 3 are communicably connected to each other via a network such as a local area network (LAN).

The server device 2 executes processes for managing various types of information of the store. For example, the server device 2 receives commodity information and settlement information of a commodity settled in a checkout process from each POS terminal 3. In addition, the server device 2 receives account settling information in which account settlement is performed on sales for a predetermined period (for example, one day) from each POS terminal 3. The server device 2 intensively manages the commodity information, the settlement information, the account settling information, and the like received from each POS terminal 3, and executes sales management and the like in one store.

The server device 2 receives a commodity code from each POS terminal 3 and transmits the commodity information (commodity name, price, and the like) corresponding to the commodity code to the corresponding POS terminal 3 to which the commodity code is transmitted. The server device 2 is an example of the information processing device.

One or more POS terminals 3 are disposed in the store. An operator (for example, a store clerk) operates the POS terminal 3, so that the POS terminal 3 executes commodity registration of a commodity to be sold. The POS terminal 3 executes the checkout process based on the registered commodity information, and transmits the commodity information and the settlement information of the commodity settled in the checkout process to the server device 2.

Next, the server device 2 will be described in detail. FIG. 2 is a block diagram showing a main electrical configuration of the server device 2. The server device 2 includes a first motherboard 20, a second motherboard 30, a base board 40, and a front board 50.

A central processing unit (CPU) 201, a memory 202, and an interface unit 203 and the like are mounted on the first motherboard 20. The CPU 201 controls the server device 2. The memory 202 stores various programs and various types of data. The interface unit 203 is an interface for communicating with the POS terminal 3 or the like. Other electronic components necessary for executing processes of the server device 2 are mounted on the first motherboard 20.

In the first motherboard 20, the CPU 201 operates in accordance with a control program stored in the memory 202 to execute a part of various control processes performed by the server device 2. The CPU 201 is an example of a processor, and the first motherboard 20 is an example of a control board.

The second motherboard 30 has the same configuration as the first motherboard 20. That is, a CPU 301, a memory 302, and an interface unit 303 and the like are mounted on the second motherboard 30. The CPU 301 controls the server device 2. The memory 302 stores various programs and various types of data. The interface unit 303 is an interface for communicating with the POS terminal 3 or the like. Other electronic components necessary for executing processes of the server device 2 are mounted on the second motherboard 30.

In the second motherboard 30, the CPU 301 operates in accordance with a control program stored in the memory 302 to execute a part of various control processes performed by the server device 2. A control process executed by the CPU 301 of the second motherboard 30 is different from the control process executed by the CPU 201 of the first motherboard 20. Functions of the server device 2 are implemented by the CPU 201 and the CPU 301 executing the control processes. In other words, the various control processes executed by the server device 2 are distributed and executed by the CPU 201 of the first motherboard 20 and the CPU 301 of the second motherboard 30. The CPU 301 is an example of the processor, and the second motherboard 30 is an example of the control board.

The base board 40 is electrically and physically connected to the first motherboard 20 and the second motherboard 30. For example, the base board 40 supports the first motherboard 20 and the second motherboard 30 while being electrically connected to the first motherboard 20 and the second motherboard 30.

A switching unit 401 and a power supply circuit unit 402 are mounted on the base board 40. The switching unit 401 connects any input and output port of the plurality of control boards to maintenance hardware 502 mounted on the front board 50. Specifically, the switching unit 401 selectively connects the input and output port of the first motherboard 20 or the input and output port of the second motherboard 30 to the maintenance hardware 502 according to an operation of a slide switch 501 mounted on the front board 50.

Here, the input and output port of the first motherboard 20 means a port for inputting a control signal from the maintenance hardware 502 mounted on the front board 50 to the CPU 201 and/or a port for outputting a control signal from the CPU 201 to the maintenance hardware 502. A plurality of input and output ports of the first motherboard 20 are provided corresponding to pieces of the maintenance hardware 502. The input and output port of the second motherboard 30 has the same configuration as that of the input and output port of the first motherboard 20, and thus redundant description will be omitted.

The switching performed by the switching unit 401 may be implemented by software processing or may be implemented by hardware.

The power supply circuit unit 402 appropriately performs voltage conversion on commercial power supply to generate supply electric power. The power supply circuit unit 402 supplies the generated electric power to each of the first motherboard 20, the second motherboard 30, the front board 50, and the base board 40.

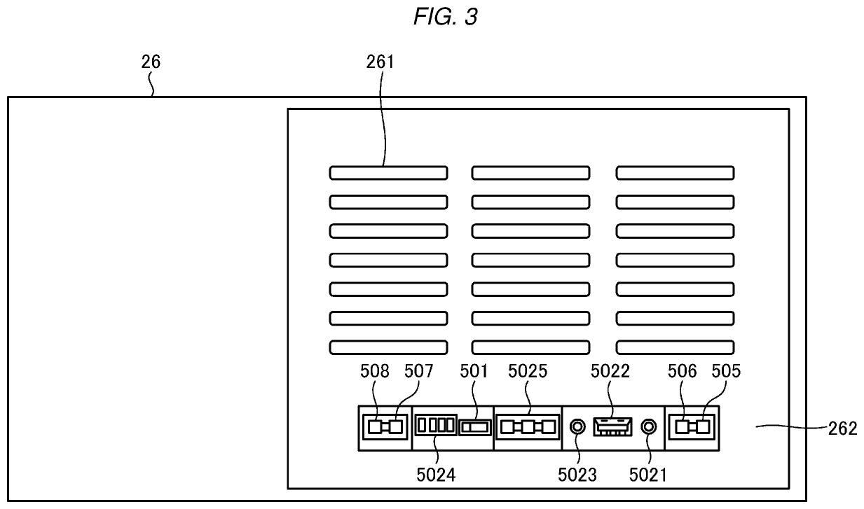

The front board 50 is provided at a position facing an outer surface 26 (see FIG. 3) in the housing of the server device 2. The slide switch 501 and the maintenance hardware 502 are mounted on the front board 50.

The slide switch 501 includes a slidable operator exposed on the outer surface 26 of the housing. The slide switch 501 is a switch for selecting one of two contact points by the operator. A first signal or a second signal is input to the switching unit 401 of the base board 40 according to the selected contact point.

When one of the contact points is selected, the first signal is input to the switching unit 401 of the base board 40. When receiving the first signal, the switching unit 401 connects the maintenance hardware 502 to the input and output port of the first motherboard. When the other one of the contact points is selected, the second signal is input to the switching unit 401 of the base board 40. When receiving the second signal, the switching unit 401 connects the maintenance hardware 502 to the input and output port of the second motherboard.

The maintenance hardware 502 is, for example, an electronic component that is operated when a service person performs maintenance on the server device 2. In the present embodiment, as the maintenance hardware 502, a reset switch 5021, a USB connector 5022, a dump switch 5023, a dip switch 5024, and a status LED 5025 are mounted on the front board 50.

The reset switch 5021 is operated, for example, when the server device 2 is in a freeze state during the maintenance. When the reset switch 5021 is operated, the CPU 201 of the first motherboard 20 or the CPU 301 of the second motherboard 30 corresponding to an input port connected to the reset switch 5021 is reset.

In the following description, connecting all or any of the maintenance hardware 502 to the input and output port of the first motherboard 20 may be referred to as “connecting the maintenance hardware 502 to the first motherboard 20”. Similarly, connecting all or any of the maintenance hardware 502 to the input and output port of the second motherboard 30 may be referred to as “connecting the maintenance hardware 502 to the second motherboard 30”.

A USB connector of an external device is connected to the USB connector 5022. For example, the USB connector 5022 is connected to a USB connector of a display or a storage device (both not shown) that outputs data of the memory 202 or the memory 302 when an error occurs in the server device 2.

The dump switch 5023 is a switch for instructing memory dump. For example, the dump switch 5023 is operated when the data of the memory 202 or the memory 302 is output and an error occurs in the server device 2. Specifically, when the dump switch 5023 is operated in a state where the dump switch 5023 is connected to the first motherboard 20 by the switching unit 401, the data of the memory 202 is output to the external device via the USB connector 5022.

The dip switch 5024 is a switch for instructing various settings of the electronic devices mounted on the first motherboard 20 or the second motherboard 30. For example, the dip switch 5024 instructs initialization of the electronic devices mounted on the first motherboard 20 or the second motherboard 30.

The status LED 5025 is implemented by one or more LEDs. The status LED 5025 according to the present embodiment is implemented by three LEDs as shown in FIG. 3. The status LED 5025 emits light in accordance with an instruction of the CPU 201 or the CPU 301, and notifies a user of various types of information by light emission patterns thereof.

For example, the status LED 5025 performs notification of an abnormality of the electronic component mounted on the first motherboard 20 or the second motherboard 30 by emitting light in one light emission pattern. The status LED 5025 changes the light emission pattern by changing a color of the light emission, changing a combination of lighting and blinking, changing a blinking speed, or the like, and notifies the user of various types of information indicated by the light emission patterns.

Other electronic components are also mounted on the front board 50. For example, a first power supply LED 505 and a first access LED 506 (both refer to FIG. 3) corresponding to the first motherboard 20 are mounted on the front board 50. The first power supply LED 505 and the first access LED 506 are always connected to the input and output port of the first motherboard 20.

The first power supply LED 505 is turned on when power is supplied to the first motherboard 20. The first access LED 506 is turned on when the CPU 201 accesses the memory 202 and reads and writes information (data).

In addition, a second power supply LED 507 and a second access LED 508 (both refer to FIG. 3) corresponding to the second motherboard 30 are mounted on the front board 50. The second power supply LED 507 and the second access LED 508 are always connected to the input and output port of the second motherboard 30.

The second power supply LED 507 is turned on when power is supplied to the second motherboard 30. The second access LED 508 is turned on when the CPU 301 accesses the memory 302 and reads and writes information (data).

The first power supply LED 505, the first access LED 506, the second power supply LED 507, and the second access LED 508 always perform notification of information during normal operation of the server device 2. Therefore, the first power supply LED 505 and the first access LED 506 are always connected to the first motherboard 20, and the second power supply LED 507 and the second access LED 508 are always connected to the second motherboard 30.

In contrast, the maintenance hardware 502 may be connected to the first motherboard 20 or the second motherboard 30 as necessary when, for example, the service person performs the maintenance on the server device 2. In the present embodiment, focusing on this point, the switching unit 41 is provided such that the maintenance hardware 502 can be selectively connected to the first motherboard 20 or the second motherboard 30. As a result, the maintenance hardware 502 can be shared by the first motherboard 20 and the second motherboard 30.

FIG. 3 is a diagram showing the outer surface 26, for example, a front surface, of the housing of the server device 2. A plurality of vent holes 261 are formed in the outer surface 26 of the housing. The vent holes 261 discharge air in the housing and take in outside air, thereby preventing a temperature rise in the housing.

An electronic component disposing portion 262 is provided below the plurality of vent holes 261. In the electronic component disposing portion 262, the various electronic components mounted on the front board 50 are exposed.

As shown in FIG. 3, the first power supply LED 505, the first access LED 506, the reset switch 5021, the USB connector 5022, the dump switch 5023, the status LED 5025, the slide switch 501, the dip switch 5024, the second power supply LED 507, and the second access LED 508 are disposed in the electronic component disposing portion 262 in this order from a right end.

The reset switch 5021, the USB connector 5022, the dump switch 5023, the dip switch 5024, and the status LED 5025 are examples of the maintenance hardware 502 used for the maintenance. The USB connector 5022 can also be used during a period of time other than the maintenance.

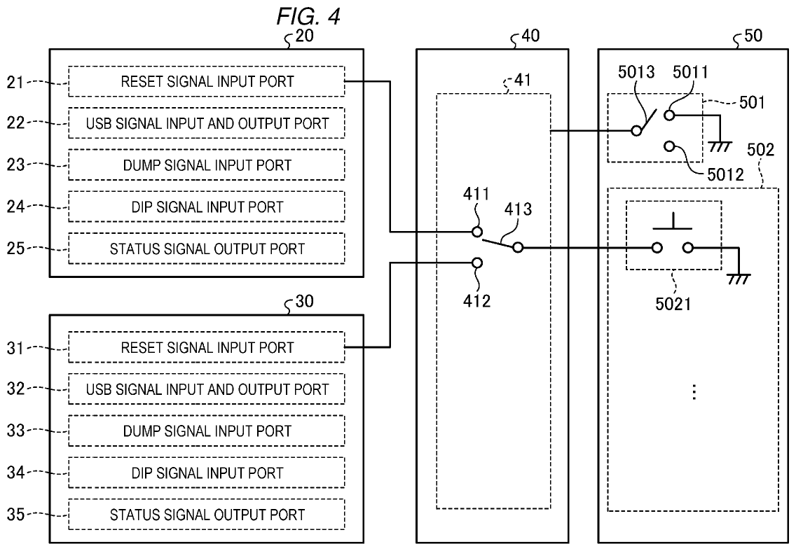

Next, the switching performed by the switching unit 41 will be described. FIG. 4 is a diagram illustrating the connection switching between the maintenance hardware 502 and the input and output ports of the control boards (the first motherboard 20 and the second motherboard 30) of the server device 2. The connection switching between each piece of the maintenance hardware 502 and each input and output port of the control board described above is the same operation, and thus, only the connection switching between the reset switch 5021 and the control board described above will be described here as a representative.

As shown in FIG. 4, the first motherboard 20 includes a reset signal input port 21, a USB signal input and output port 22, a dump signal input port 23, a dip signal input port 24, and a status signal output port 25.

A signal based on an operation of the reset switch 5021 of the front board 50 is input to the reset signal input port 21. A signal from the USB connector 5022 of the front board 50 is input to the USB signal input and output port 22. The USB signal input and output port 22 outputs a signal from the CPU 201 to the USB connector 5022 of the front board 50.

A signal based on an operation of the dump switch 5023 of the front board 50 is input to the dump signal input port 23. A signal based on an operation of the dip switch 5024 of the front board 50 is input to the dip signal input port 24. The status signal output port 25 outputs a signal from the CPU 201 to the status LED of the front board 50.

The second motherboard 30 has the same configuration as the first motherboard 20. That is, the second motherboard 30 includes a reset signal input port 31, a USB signal input and output port 32, a dump signal input port 33, a dip signal input port 34, and a status signal output port 35. Functions of these input and output ports are the same as the functions of the input and output ports of the first motherboard 20, and thus redundant description will be omitted.

The base board 40 includes the switching unit 41. FIG. 4 conceptually shows a configuration of the switching unit 41. In the switching unit 41, a connector 413 is connected to a first contact point 411 or a second contact point 412 according to a signal input based on the operation of the slide switch 501.

When the first signal is received from the slide switch 501, the switching unit 41 connects the connector 413 to the first contact point 411. Accordingly, the maintenance hardware 502 is connected to the first motherboard 20. In addition, when the second signal is received from the slide switch 501, the switching unit 41 connects the connector 413 to the second contact point 412. Accordingly, the maintenance hardware 502 is connected to the second motherboard 30.

The front board 50 includes the slide switch 501 and the maintenance hardware 502. In FIG. 4, the reset switch 5021 is shown, and other pieces of the maintenance hardware 502 are omitted.

In the slide switch 501, a connector 5013 is connected to a first contact point 5011 or a second contact point 5012. When the connector 5013 is connected to the first contact point 5011 by an operation of a user, the slide switch 501 outputs the first signal. In addition, when the connector 5013 is connected to the second contact point 5012 by the operation of the user, the slide switch 501 outputs the second signal.

In FIG. 4, when the maintenance is performed on the first motherboard 20, the service person operates the slide switch 501 to connect the connector 5013 to the first contact point 5011. The slide switch 501 outputs the first signal to the switching unit 41.

When the first signal is received from the slide switch 501, the switching unit 41 connects the connector 413 to the first contact point 411. Accordingly, the reset switch 5021 is connected to the reset signal input port 21 via the switching unit 41.

When the service person operates the reset switch 5021 to turn on the reset switch 5021 in this state, a reset signal instructing the CPU 201 to be reset is input to the CPU 201 via the reset signal input port 21.

When a USB connector of an external device is connected to the USB connector 5022 in the state where the connector 413 is connected to the first contact point 411, information is received from the external device to the CPU 201 via the USB signal input and output port 22, or information is received from the CPU 201 to the external device. When the dump switch 5023 is operated in the state where the connector 413 is connected to the first contact point 411, a dump signal instructing the memory dump is input to the CPU 201 via the dump signal input port 23.

When the dip switch 5024 is operated in the state where the connector 413 is connected to the first contact point 411, a dip signal indicating setting information is input to the CPU 201 via the dip signal input port 24. When a status signal is output from the CPU 201 in the state where the connector 413 is connected to the first contact point 411, the status signal is input to the status LED 5025 via the status signal output port 25.

When the connector 5013 of the slide switch 501 is connected to the second contact point 5012, the slide switch 501 outputs the second signal to the switching unit 41. When the second signal is received from the slide switch 501, the switching unit 41 connects the connector 413 to the second contact point 412. Accordingly, the reset switch 5021 is connected to the reset signal input port 31 via the switching unit 41.

The inputs and outputs of signals between the CPU 301 and the USB connector 5022, between the CPU 301 and the dump switch 5023, between the CPU 301 and the dip switch 5024, and between the CPU 301 and the status LED 5025 in the state where the connector 413 is connected to the second contact point 412 are the same as the inputs and outputs of signals to and from the CPU 201 in the state where the connector 413 is connected to the first contact point 411.

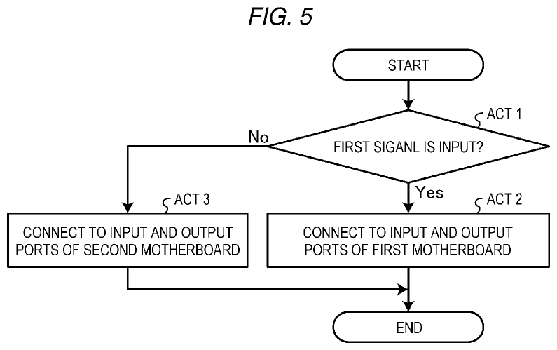

FIG. 5 is a flowchart showing a flow of a switching process performed by the switching unit 41. When the first signal is input by the operation of the slide switch 501 (Y in ACT 1), the switching unit 41 connects the pieces of the maintenance hardware 502 to the input and output ports of the first motherboard 20 (ACT 2). Specifically, the switching unit 41 connects the connector 413 to the first contact point 411. Then, the switching unit 41 ends the switching process.

When the first signal is not input (N in ACT 1), in other words, when the second signal is input, the switching unit 41 connects the pieces of the maintenance hardware 502 to the input and output ports of the second motherboard 30 (ACT 3). Specifically, the switching unit 41 connects the connector 413 to the second contact point 412. Then, the switching unit 41 ends the switching process.

According to the above switching process, the maintenance hardware 502 can be connected to the first motherboard 20 or the second motherboard 30 based on the operation of the slide switch 501. As a result, the maintenance hardware 502 can be shared by the first motherboard 20 and the second motherboard 30.

As described above, the server device 2 according to the embodiment is an information processing device (the server device 2) provided in the housing with a plurality of control boards (the first motherboard 20 and the second motherboard 30) on which processors (the CPUs 201 and 301) and memories 202 and 302 are mounted, and functioning by processes of the processors mounted on the plurality of control boards. The information processing device includes the maintenance hardware 502 used when the maintenance is performed on the information processing device, and the switching unit 41 selectively connecting an input and output port of any one of the plurality of control boards to the maintenance hardware 502.

Accordingly, in the server device 2, the maintenance hardware 502 can be shared by the first motherboard 20 and the second motherboard 30. Therefore, in the server device 2, it is not necessary to provide the maintenance hardware 502 for each of the first motherboard 20 and the second motherboard 30. Accordingly, the server device 2 can be miniaturized.

In addition, in the server device 2 according to the embodiment, the maintenance hardware 502 is an electronic component provided on the outer surface 26 of the housing.

Accordingly, in the server device 2, the electronic components provided on the outer surface 26 of the housing can be shared by the first motherboard 20 and the second motherboard 30, so that the number of electronic components provided on the outer surface 26 of the housing can be reduced. Therefore, an appearance of the server device 2 is improved, and operability with respect to the electronic components provided on the outer surface 26 of the housing can be improved.

Further, in the server device 2 according to the embodiment, the switching unit 41 switches an input and output port of a control board (motherboard) to be connected to the maintenance hardware 502 based on the operation of the slide switch 501 provided on the outer surface 26 of the housing.

Accordingly, a switching operation performed by the service person who performs the maintenance can be facilitated.

Although the embodiment according to the disclosure is described above, the embodiment is presented as an example and is not intended to limit the scope of the disclosure. Such new exemplary embodiments and modifications thereof can be implemented in other various forms, and various omissions, replacements, and changes can be made without departing from the spirit of the exemplary embodiments described herein. The accompanying claims and their equivalents are intended to cover such forms or modifications as would fall within the scope and spirit of the exemplary embodiments.

What is claimed is:

1. An information processing device provided in a housing with a plurality of control boards on which processors and memories are mounted, the information processing device comprising:
maintenance hardware configured for use when maintenance is performed on the information processing device; and
a switching component configured to selectively connect an input and output port of any one of the plurality of control boards to the maintenance hardware.

2. The information processing device according to claim 1, wherein
the maintenance hardware is an electronic component provided on an outer surface of the housing.

3. The information processing device according to claim 1, wherein
the switching component switches an input and output port of a control board for connection to the maintenance hardware based on an operation of a slide switch provided on an outer surface of the housing.

4. The information processing device according to claim 3, wherein the slide switch is a switch for selecting one of two contact points by an operator.

5. The information processing device according to claim 3, wherein
the maintenance hardware includes one or more of a USB connector, a reset switch, a dump switch, a dip switch, and a status LED.

6. The information processing device according to claim 1, wherein
the input and output port of a first motherboard is a port for inputting a control signal from the maintenance hardware mounted on a front board to a CPU or a port for outputting a control signal from the CPU to the maintenance hardware.

7. The information processing device according to claim 1, wherein
the maintenance hardware is connected to a first motherboard or a second motherboard when a service person performs maintenance.

8. The information processing device according to claim 1, wherein
the switching component is a hardware switch or a software switch.

9. A personal computer, comprising:
a housing;
a plurality of control boards on which processors and memories are mounted;
maintenance hardware configured for use when maintenance is performed on the information processing device; and
a switching component configured to selectively connect an input and output port of any one of the plurality of control boards to the maintenance hardware.

10. The personal computer according to claim 9, wherein
the maintenance hardware is an electronic component provided on an outer surface of the housing.

11. The personal computer according to claim 9, wherein
the switching component switches an input and output port of a control board for connection to the maintenance hardware based on an operation of a slide switch provided on an outer surface of the housing.

12. The personal computer according to claim 11, wherein the slide switch is a switch for selecting one of two contact points by an operator.

13. The personal computer according to claim 11, wherein
the maintenance hardware includes one or more of a USB connector, a reset switch, a dump switch, a dip switch, and a status LED.

14. The personal computer according to claim 9, wherein
the input and output port of a first motherboard is a port for inputting a control signal from the maintenance hardware mounted on a front board to a CPU or a port for outputting a control signal from the CPU to the maintenance hardware.

15. A point of sale server system, comprising:
a housing with a plurality of control boards on which processors and memories are mounted;
maintenance hardware configured for use when maintenance is performed on the information processing device; and
a switching component configured to selectively connect an input and output port of any one of the plurality of control boards to the maintenance hardware.

16. The point of sale server system according to claim 15, wherein
the maintenance hardware is an electronic component provided on an outer surface of the housing.

17. The point of sale server system according to claim 15, wherein
the switching component switches an input and output port of a control board for connection to the maintenance hardware based on an operation of a slide switch provided on an outer surface of the housing.

18. The point of sale server system according to claim 17, wherein the slide switch is a switch for selecting one of two contact points by an operator.

19. The point of sale server system according to claim 17, wherein
the maintenance hardware includes one or more of a USB connector, a reset switch, a dump switch, a dip switch, and a status LED.

20. The point of sale server system according to claim 15, wherein
the input and output port of a first motherboard is a port for inputting a control signal from the maintenance hardware mounted on a front board to a CPU or a port for outputting a control signal from the CPU to the maintenance hardware.
